(19) United States
(12) Patent Application Publication
(10) Pub. No.: US 2025/0219279 A1
(43) Pub. Date: Jul. 3, 2025

(54) MODULAR ANTENNA SLEEVE ASSEMBLIES AND DOWNHOLE LOGGING TOOL

(71) Applicant: Halliburton Energy Services, Inc., Houston, TX (US)

(72) Inventor: Minh Dang NGUYEN, Houston, TX (US)

(73) Assignee: Halliburton Energy Services, Inc., Houston, TX (US)

(21) Appl. No.: 18/402,729

(22) Filed: Jan. 3, 2024

(51) Int. Cl. H01Q 1/04; E21B 47/017; H01Q 1/22

(52) U.S. Cl. CPC H01Q 1/04; E21B 47/017; H01Q 1/22

(57) ABSTRACT

A modular antenna sleeve assembly includes an antenna and an antenna sleeve having a wiring hole to receive wiring of the antenna. The modular antenna sleeve assembly also includes a protection sleeve disposed around the antenna sleeve and configured to shield the antenna. The modular antenna sleeve assembly further includes a locking sleeve disposed around the antenna sleeve and configured to hold the protection sleeve in position while the locking sleeve is in a locked position.

### BACKGROUND

The present disclosure relates generally to modular antenna sleeve assemblies and downhole logging tools.

Downhole antennas are often built onto a collar of a downhole tool, which reduces the antennas' ability to withstand downhole torque, bending moment, and pressure. Further, antennas that are built onto a collar are often difficult to repair and maintain due to the size of the collar.

### BRIEF DESCRIPTION OF THE DRAWINGS

Illustrative embodiments of the present disclosure are described in detail below with reference to the attached drawing figures, which are incorporated by reference herein, and wherein:

FIG. 1 illustrates a diagrammatic view of an example Logging while drilling (LWD)/measurement while drilling (MWD) wellbore operating environment;

FIG. 2 is a cross-sectional view of a logging tool that is deployable in the environment of FIG. 1; and

FIG. 3 is a cross-sectional view of a modular antenna sleeve assembly similar to the modular antenna sleeve assembly of FIG. 2.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to modular antenna sleeve assemblies and downhole logging tools. The present disclosure relates to modular antenna sleeve assemblies and downhole logging tools. A modular antenna sleeve assembly includes an antenna sleeve having a wiring hole that is configured to receive antenna wiring through the antenna hole. The antenna sleeve has an exterior surface that provides access to antenna coil. In some embodiments, the antenna coils are wrapped around a section of the exterior surface. In some embodiments, the antenna sleeve is coupled to or is adjacent to an antenna spool that feeds antenna wiring through the wiring hole.

The antenna sleeve is coupled to a protection sleeve that is positioned around and over a section of the exterior surface of the antenna sleeve to protect the antenna coil from external elements during downhole operations. The modular antenna sleeve assembly also includes a locking sleeve that is disposed around the antenna sleeve and configured to hold the protection sleeve in position while the locking sleeve is in a locked position. In some embodiments, the locking sleeve is a shrink-fit metal sleeve configured to shrink-fit onto the antenna sleeve while the locking sleeve is in the locked position. In one or more of such embodiments, the antenna is accessible after both the locking sleeve and the protection sleeve are removed from the modular antenna sleeve assembly.

In some embodiments, the antenna sleeve assembly also includes an insulator positioned around the antenna and configured to provide insulation for the antenna coils. In some embodiments, the antenna sleeve assembly has one or more holes formed through the sleeves of the antenna sleeve assembly, where the holes are configured to balance pressure within the modular antenna sleeve assembly. In one or more of such embodiments, the antenna sleeve assembly includes a magnetic rubber wrap wrapped along an interior surface of the antenna sleeve and configured to seal pressure within the modular antenna sleeve assembly.

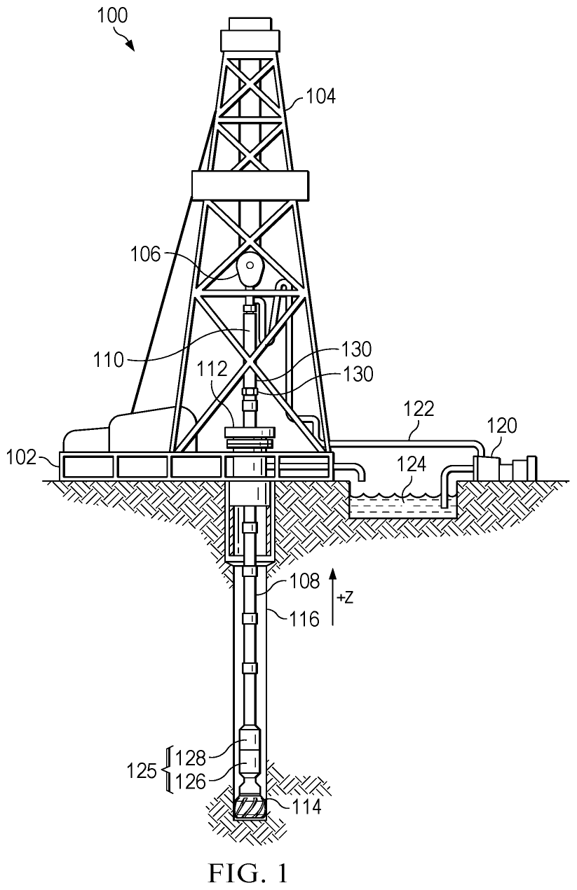

A downhole logging tool includes an insert and a modular antenna sleeve assembly described herein. In some embodiments, the logging tool includes a ring (e.g., a spacer ring) positioned adjacent to the antenna sleeve and the locking sleeve, and configured to hold the antenna sleeve and the locking sleeve in position. In some embodiments, the downhole tool also includes a magnet or magnetic array positioned around the insert, where the magnet is held in position by the antenna sleeve. In some embodiments, the downhole tool also includes a locking sub configured to lock the modular antenna sleeve assembly in position while the locking sub is in a locked position. Additional descriptions of modular antenna sleeve assemblies and downhole logging tools are provided in the paragraphs below and are illustrated in FIGS. 1-3.

Turning now to the figures, FIG. 1 illustrates a diagrammatic view of an exemplary LWD/MWD wellbore operating environment 100 in which the present disclosure may be implemented. As depicted in FIG. 1, a drilling platform 102 is equipped with a derrick 104 that supports a hoist 106 for raising and lowering a drill string 108. The hoist 106 suspends a top drive 110 suitable for rotating the drill string 108 and lowering the drill string 108 through the well head 112. Connected to the lower end of the drill string 108 is a drill bit 114. As the drill bit 114 rotates, the drill bit 114 creates a wellbore 116 that passes through various formations. A pump 120 circulates drilling fluid through a supply pipe 122 to top drive 110, down through the interior of drill string 108, through orifices in drill bit 114, back to the surface via the annulus around drill string 108, and into a retention pit 124. The drilling fluid transports cuttings from the wellbore 116 into retention pit 124 and aids in maintaining the integrity of the wellbore 116. Various materials can be used for drilling fluid, including oil-based fluids and water-based fluids.

As depicted in FIG. 1, LWD/MWD tools (collectively “logging tool”) 126 are integrated into the bottom-hole assembly 125 near the drill bit 114. As the drill bit 114 extends to the wellbore 116 through the various formations, logging tool 126 collects measurements relating to various formation properties, as well as the orientation of the tool and various other drilling conditions.

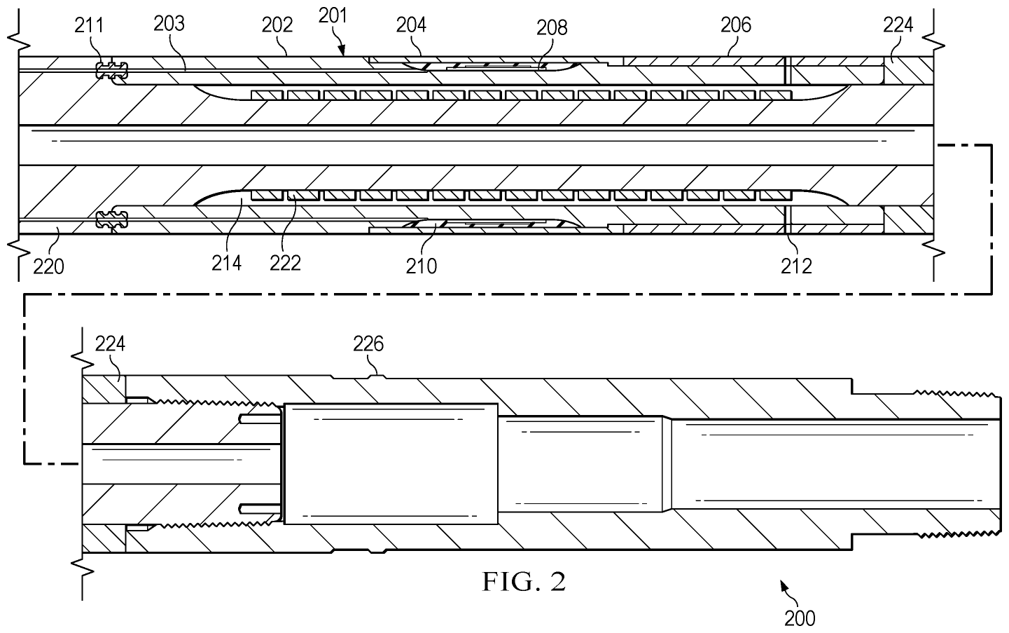

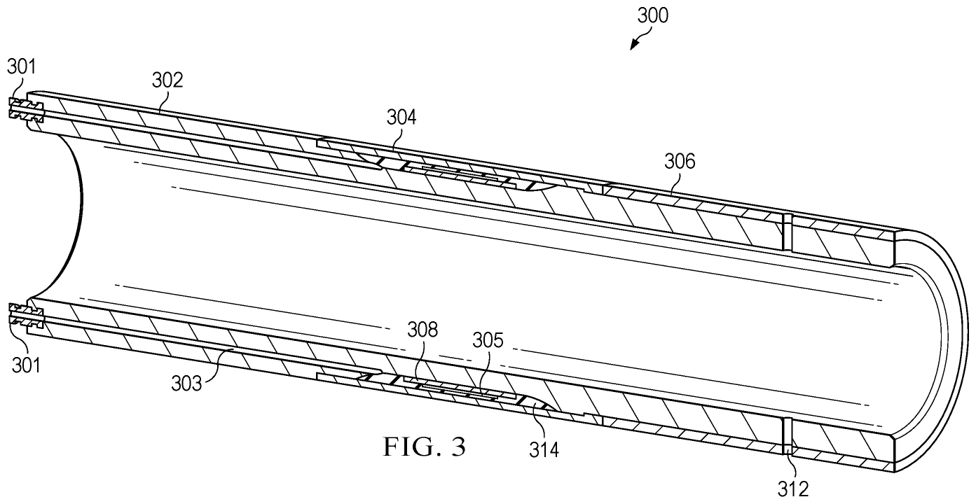

In the embodiment of FIG. 1, logging tool 126 includes a modular antenna sleeve assembly 128 that is also integrated into the bottom-hole assembly 125. Modular antenna sleeve assembly 128 includes an antenna sleeve having a wiring hole to receive wiring of the antenna, a protection sleeve disposed around the antenna sleeve and configured to shield the antenna, and a locking sleeve disposed around the antenna sleeve and configured to hold the protection sleeve in position while the locking sleeve is in a locked position. Additional descriptions of similar modular antenna sleeve assemblies and downhole logging tool are provided herein and are illustrated in at least FIGS. 2-3.

FIG. 2 is a cross-sectional view of a logging tool 200 that is deployable in the environment of FIG. 1. In the embodiment of FIG. 2, logging tool 200 includes a modular antenna sleeve assembly 201 coupled to a section of an insert 220 that has a magnetic array 222 wrapped around the exterior of the section of insert 220. In the embodiment of FIG. 2, a magnetic rubber wrap 214 is wrapped around magnetic array 222 to pressure seal magnetic array 222.

Modular antenna sleeve assembly 201 has an antenna sleeve 202 coupled to an antenna spool 211 that provides antenna coil through a wiring hole 203 of antenna sleeve 202 to an exterior section of antenna sleeve 202 that is accessible. Modular antenna sleeve assembly 201 also includes a protection sleeve 204 disposed around antenna sleeve 202 and configured to shield the antenna coil from external elements. Protection sleeve 204 is coupled to a locking sleeve 206 that is disposed around antenna sleeve 202 and configured to hold protection sleeve 204 in position while the locking sleeve 206 is in a locked position. In some embodiments, both locking sleeve 206 and protection sleeve 204 are removable to provide access to the antenna. In one or more of such embodiments, locking sleeve 206 and protection sleeve 204 are repositioned onto antenna sleeve 202 to protect the antenna coil when access to the antenna is no longer needed. An insulator 208 is positioned around a section of the antenna to insulate the antenna during downhole operations. Further, a wrap 210 is positioned around a section of antenna sleeve 202 to pressure seal the section of antenna sleeve 202. A hole 212 is formed through a section of antenna sleeve 202 and locking sleeve 206 to provide pressure balance.

Logging tool 200 includes a ring (e.g., a spacer ring) 224 that is positioned around insert 220 and adjacent to antenna sleeve 202 and locking sleeve 206. In the embodiment of FIG. 2, logging tool 200 also include a locking crossover sub 226 positioned adjacent to insert 220 and ring 224, where crossover sub 226 is configured to hold modular antenna sleeve assembly 201 in position while locking crossover sub 226 is in a locked position.

FIG. 3 is a cross-sectional view of a modular antenna sleeve assembly 300 similar to modular antenna sleeve assembly 200 of FIG. 2. In the embodiment of FIG. 3, modular antenna sleeve assembly 300 has an antenna sleeve 202 coupled to an antenna spool 301 that provides antenna coil 305 through a wiring hole 303 of antenna sleeve 302 to an exterior section of antenna sleeve 302 that is accessible. Modular antenna sleeve assembly 300 also includes a protection sleeve 304 disposed around antenna sleeve 302 and configured to shield the antenna coil 305 from external elements.

Protection sleeve 304 is coupled to a locking sleeve 306 that is disposed around antenna sleeve 302 and configured to hold protection sleeve 304 in position while the locking sleeve 306 is in a locked position. In some embodiments, both locking sleeve 306 and protection sleeve 304 are removable to provide access to the antenna. In one or more of such embodiments, locking sleeve 306 and protection sleeve 304 are repositioned onto antenna sleeve 302 to protect antenna coil 305 when access to the antenna is no longer needed. An insulator 308 is positioned around a section of the antenna to insulate the antenna during downhole operations. Further, a wrap 314 is positioned around a section of antenna sleeve 302 to pressure seal the section of antenna sleeve 302. A hole 312 is formed through a section of antenna sleeve 302 and locking sleeve 306 to provide pressure balance.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence, or combined into a single step/process. The scope of the claims is intended to broadly cover the disclosed embodiments and any such modification. Further, the following clauses represent additional embodiments of the disclosure and should be considered within the scope of the disclosure.

Clause 1, a modular antenna sleeve assembly, comprising an antenna; an antenna sleeve having a wiring hole to receive wiring of the antenna; a protection sleeve disposed around the antenna sleeve and configured to shield the antenna; and a locking sleeve disposed around the antenna sleeve and configured to hold the protection sleeve in position while the locking sleeve is in a locked position.

Clause 2, the antenna sleeve assembly of clause 1, further comprising an insulator positioned around the antenna and configured to provide insulation for the antenna.

Clause 3, the antenna sleeve assembly of clauses 1 or 2, wherein the locking sleeve is a shrink-fit metal sleeve configured to shrink-fit onto the antenna sleeve while the locking sleeve is in the locked position.

Clause 4, the antenna sleeve assembly of clauses 1-3, wherein the antenna sleeve further comprises a hole configured to balance pressure within the modular antenna sleeve assembly.

Clause 5, the antenna sleeve assembly of clauses 1-4, further comprising a magnetic rubber wrap wrapped along an interior surface of the antenna sleeve and configured to seal pressure within the modular antenna sleeve assembly.

Clause 6, the modular antenna sleeve assembly of clauses 1-5, wherein the wiring is wrapped along an exterior surface of the antenna sleeve.

Clause 7, the modular antenna sleeve assembly of clause 6, wherein the wiring is exposed and accessible along a section of the exterior surface of the antenna sleeve after the protection sleeve is removed from the modular antenna sleeve assembly.

Clause 8, the modular antenna sleeve assembly of clauses 1-7, further comprising an antenna spool positioned adjacent to the wiring hole of the antenna sleeve and configured to provide the wiring through the wiring hole.

Clause 9, a downhole logging tool comprising an insert; and a modular antenna sleeve assembly wrapped around the insert, comprising: an antenna; an antenna sleeve having a wiring hole to receive wiring of the antenna; and a protection sleeve disposed around the antenna sleeve and configured to shield the antenna.

Clause 10 the downhole logging tool of clause 9, wherein the modular antenna sleeve assembly further comprises a locking sleeve disposed around the antenna sleeve and configured to hold the protection sleeve in position while the locking sleeve is in a locked position.

Clause 11, the downhole logging tool of clause 10, further comprising a ring positioned adjacent to the antenna sleeve and the locking sleeve, and configured to hold the antenna sleeve and the locking sleeve in position.

Clause 12, the downhole logging tool of clause 11, wherein the locking sleeve is a shrink-fit metal sleeve configured to shrink-fit onto the antenna sleeve while the locking sleeve is in the locked position.

Clause 13, the downhole logging tool of clauses 9-11, further comprising a magnet positioned around the insert, wherein the magnet is held in position by the antenna sleeve.

Clause 14, the downhole logging tool of clauses 9-13, further comprising an insulator positioned around the antenna and configured to provide insulation for the antenna.

Clause 15, downhole logging tool of clauses 9-14, wherein the antenna sleeve further comprises a hole configured to balance pressure within the modular antenna sleeve assembly.

Clause 16, the downhole logging tool of clauses 9-15, further comprising a magnetic rubber wrap wrapped along an interior surface of the antenna sleeve and configured to seal pressure within the modular antenna sleeve assembly.

Clause 17, the downhole logging tool of clauses 9-16, wherein the wiring is wrapped along an exterior surface of the antenna sleeve.

Clause 18, the downhole logging tool of clause 17, wherein the wiring is exposed and accessible along a section of the exterior surface of the antenna sleeve after the protection sleeve is removed from the modular antenna sleeve assembly.

Clause 19, the downhole logging tool of clauses 9-18, further comprising an antenna spool positioned adjacent to the wiring hole of the antenna sleeve and configured to provide the wiring through the wiring hole.

Clause 20, the downhole logging tool of clauses 9-19, further comprising a locking sub configured to lock the modular antenna sleeve assembly in position while the locking sub is in a locked position.

As used herein, the singular forms “a,” “an,” and “the” are intended to include the plural forms as well, unless the context clearly indicates otherwise. It will be further understood that the terms “comprise” and/or “comprising,” when used in this specification and/or in the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

1. A modular antenna sleeve assembly, comprising:
an antenna;
an antenna sleeve having a wiring hole to receive wiring of the antenna;
a protection sleeve disposed around the antenna sleeve and configured to shield the antenna; and
a locking sleeve disposed around the antenna sleeve and configured to hold the protection sleeve in position while the locking sleeve is in a locked position.

2. The antenna sleeve assembly of claim 1, further comprising an insulator positioned around the antenna and configured to provide insulation for the antenna.

3. The antenna sleeve assembly of claim 1, wherein the locking sleeve is a shrink-fit metal sleeve configured to shrink-fit onto the antenna sleeve while the locking sleeve is in the locked position.

4. The antenna sleeve assembly of claim 1, wherein the antenna sleeve further comprises a hole configured to balance pressure within the modular antenna sleeve assembly.

5. The antenna sleeve assembly of claim 1, further comprising a magnetic rubber wrap wrapped along an interior surface of the antenna sleeve and configured to seal pressure within the modular antenna sleeve assembly.

6. The modular antenna sleeve assembly of claim 1, wherein the wiring is wrapped along an exterior surface of the antenna sleeve.

7. The modular antenna sleeve assembly of claim 6, wherein the wiring is exposed and accessible along a section of the exterior surface of the antenna sleeve after the protection sleeve is removed from the modular antenna sleeve assembly.

8. The modular antenna sleeve assembly of claim 1, further comprising an antenna spool positioned adjacent to the wiring hole of the antenna sleeve and configured to provide the wiring through the wiring hole.

9. A downhole logging tool comprising:
an insert; and
a modular antenna sleeve assembly wrapped around the insert, comprising:
an antenna;
an antenna sleeve having a wiring hole to receive wiring of the antenna; and
a protection sleeve disposed around the antenna sleeve and configured to shield the antenna.

10. The downhole logging tool of claim 9, wherein the modular antenna sleeve assembly further comprises a locking sleeve disposed around the antenna sleeve and configured to hold the protection sleeve in position while the locking sleeve is in a locked position.

11. The downhole logging tool of claim 10, further comprising a ring positioned adjacent to the antenna sleeve and the locking sleeve, and configured to hold the antenna sleeve and the locking sleeve in position.

12. The downhole logging tool of claim 11, wherein the locking sleeve is a shrink-fit metal sleeve configured to shrink-fit onto the antenna sleeve while the locking sleeve is in the locked position.

13. The downhole logging tool of claim 9, further comprising a magnet positioned around the insert, wherein the magnet is held in position by the antenna sleeve.

14. The downhole logging tool of claim 9, further comprising an insulator positioned around the antenna and configured to provide insulation for the antenna.

15. The downhole logging tool of claim 9, wherein the antenna sleeve further comprises a hole configured to balance pressure within the modular antenna sleeve assembly.

16. The downhole logging tool of claim 9, further comprising a magnetic rubber wrap wrapped along an interior surface of the antenna sleeve and configured to seal pressure within the modular antenna sleeve assembly.

17. The downhole logging tool of claim 9, wherein the wiring is wrapped along an exterior surface of the antenna sleeve.

18. The downhole logging tool of claim 17, wherein the wiring is exposed and accessible along a section of the exterior surface of the antenna sleeve after the protection sleeve is removed from the modular antenna sleeve assembly.

19. The downhole logging tool of claim 9, further comprising an antenna spool positioned adjacent to the wiring hole of the antenna sleeve and configured to provide the wiring through the wiring hole.

20. The downhole logging tool of claim 9, further comprising a locking sub configured to lock the modular antenna sleeve assembly in position while the locking sub is in a locked position.
